(19) United States
(12) Patent Application Publication
(10) Pub. No.: US 2009/0192865 A1
(43) Pub. Date: Jul. 30, 2009

(54) Group profiling with electronic offers

(75) Inventors: Harry Raymond Soza, San Jose, CA (US); Juraj George Fandli, Campbell, CA (US); William John Thomas, Newtown, PA (US); Stephen J. Brown, Woodside, CA (US)

Correspondence Address: LUMEN PATENT FIRM, 2345 YALE STREET, SECOND FLOOR, PALO ALTO, CA, 94306, US

(73) Assignee: Internet Consumer Exchange

(21) Appl. No.: 12/012,058

(22) Filed: Jan. 30, 2008

(51) Int. Cl. G06Q 10/00; G06Q 30/00

(52) U.S. Cl. 705/10; 705/14

(57) ABSTRACT

Group profiling with offers distributed through affinity groups is provided. Each affinity group has members who have pre-existing relationships with the affinity group. Savings offers from sponsors are distributed to affinity group members. A member of an affinity group accesses and receives one or more offers through a forum, such as a website, established by the same affinity group. Each distributed offer includes an identifier that is associated with a product and is associated with the affinity group of the member receiving the offer. Upon redemption of an offer at a store, redemption data is recorded and used for profiling the affinity group associated with the identifier of the redeemed offer. The group profiling enables sponsors to find the reach, relevance, and influence of the affinity groups and enables affinity groups to find the most valued offers for their members.

### BACKGROUND

Manufacturers and commercial enterprises regularly use discount coupons to attract consumers to their products, build consumer rapport, and provide marketing information for future business decisions. Traditionally, the commercial enterprises themselves must find ways to distribute the coupons to consumers. These distribution methods often use print media, such as advertising mailings and newspapers. The traditional methods of coupon distribution are often costly and have limited success as the mailings can be a nuisance to potential consumers.

Many commercial enterprises employ electronic media to distribute electronic coupons. Oftentimes, however, the traditional distribution methods are simply replaced by Internet-based distribution methods resulting in the same failures and difficulties. For example, an electronic coupon can be offered to a potential customer by sending an unsolicited electronic mail to the customer or an electronic coupon can be posted as an advertisement on a webpage. In the latter example, commercial enterprises are required to expend resources to direct coupons to potential customers or establish their own webpages to distribute their coupons. Consumers are hesitant to use coupons that are unsolicited and even those consumers seeking coupons would have difficulties finding the appropriate ones amongst a multitude of webpages. Furthermore, the many different websites typically have many different requirements, which may be cumbersome to potential customers.

Centralized coupon distribution services, e.g. MyCoupons.com, are available to distribute coupons from multiple commercial enterprises to individual consumers. A centralized distribution service typically has a website where individual consumers can select coupons from multiple manufacturers. However, consumers may not know about the website or the coupon distributing website can be difficult to find. The consumer is typically unfamiliar with the coupon distribution website and would naturally have reservations about using the website. A consumer would question the validity of the coupons offered at the website. The coupon distribution service also typically requires users to register and log on to the website, where registering generally entails filling out multiple forms and submitting user information. This registration data can be used for marketing analysis. Consumers are hesitant to enter personal information, particularly to an unfamiliar website. For at least these difficulties, traditional centralized coupon distribution services can be unpopular and would limit marketing analyses.

The present invention addresses the difficult problem of distribution of electronic offers.

### SUMMARY OF THE INVENTION

The present invention is directed to group profiling in an offer and reward system. The offer and reward system includes an offer exchange system, a plurality of sponsors, and a plurality of affinity groups. Affinity groups can be an organization, a religious organization, a school, a bank, a team, a company, a special interest group, an online community, an online social network, an insurance group, or any combination thereof. Members of each of the affinity groups have pre-existing relationships with the affinity group. The sponsors submit offers to the offer exchange system, which includes an offer database for storing the offers. The offers can be for discounts on products and are redeemable at one or more physical or online stores.

The offer exchange system includes a mechanism to distribute the offers to be received by the members of the affinity groups. A member of an affinity group receives an offer distributed by the offer exchange system through a forum established by the affinity group. Affinity group forums are preferably websites, though they can also be a physical newsletter, an online newsletter, a mailing, an online mailing, an electronic mail, or any combination thereof.

Each distributed offer includes an identifier, preferably in the form of a bar code. The identifier is associated with a product and associated with an affinity group of the member receiving the distributed offer. Optionally, the identifier can also be associated with the individual member receiving the offer. After or upon redemption of the offer at a store, redemption data is recorded. The redemption data identifies the store and/or region where the offer was redeemed and the time of redemption. The offer exchange system includes a receive mechanism for receiving the redemption data, possibly through a redemption agent.

The offer exchange system also includes a group profiler for profiling the affinity group associated with the identifier on a redeemed offer based on the redemption data. The group profiler can also use one or more group properties of the affinity groups for profiling. The group properties, such as demographic data, can be stored in a group database of the offer exchange system. The group profiling can also include calculating an effective cost per number of impressions (eCPM) as a function of the redemption data and the group properties.

Sponsor rules and affinity group rules are also provided. Sponsor rules are determined by the sponsors to place restrictions on the offers. Affinity groups can also determine affinity group rules. The offer exchange system stores and manages sponsor rules and affinity group rules to determine what offers can be distributed to which members of the affinity groups.

### BRIEF DESCRIPTION OF THE FIGURES

The present invention together with its objectives and advantages will be understood by reading the following description in conjunction with the drawings, in which:

FIG. 1 shows a schematic of a system for profiling groups with electronic offers according to the present invention.

FIG. 2 shows a flow chart of steps undertaken by member M* in FIG. 1 to receive and redeem an electronic offer according to the present invention.

FIG. 3A shows an example of a group website with a link to an offer website according to the present invention.

FIG. 3B shows an example of an offer website for distributing offers according to the present invention.

FIG. 4 shows an example of a group website with an offer retrieved by an embedded script according to the present invention.

FIG. 5 shows a schematic of a system for profiling groups with electronic offers, sponsor rules, and affinity group rules according to the present invention.

### DETAILED DESCRIPTION OF THE INVENTION

Discount offers create savings opportunities for users and create valuable marketing opportunities for sponsors who create the offers. However, the distribution of the offers to a large number of users, which requires a trustworthy and easy to use environment, can be difficult. Below is a detailed description of distributing offers to members of affinity groups and profiling the affinity groups by using the redemption information from the offers.

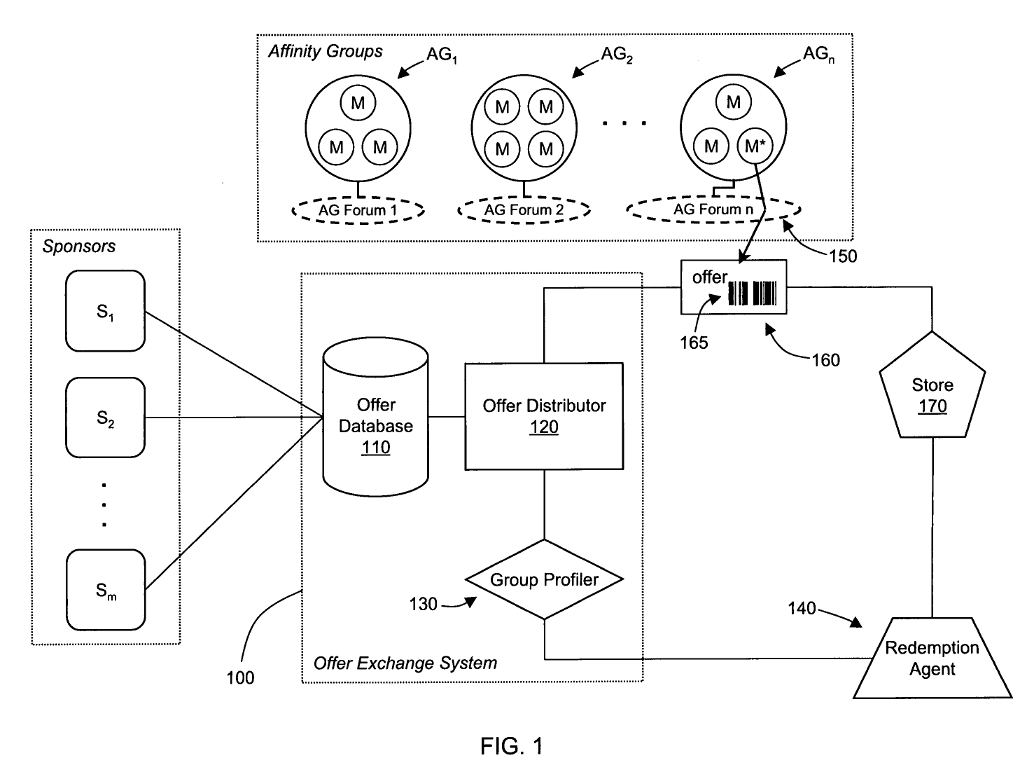

FIG. 1 shows a schematic of an offer and reward system of the present invention. The offer and reward system includes multiple sponsors S₁-Sₘ who create offers containing discounts lo for products. A product includes any manufactured product, food product, service, or any other item desirable to a potential customer. A discount includes a reduction in price for a product, an available free product, or any other savings incentive. The sponsors S₁-Sₘ can be manufacturers of the products or a third party with a goal of releasing offers to be received by potential customers. The offers are redeemable at one or more stores 170. A store 170 can be a physical brick and mortar store or an online retailer.

The customers receiving the offers in the offer and reward system of FIG. 1 are members M of affinity groups AG₁-AGₙ. It is important to note that the members M of each of the affinity groups AG₁-AGₙ have pre-existing relationships with the affinity groups AG₁-AGₙ. In other words, a member M of an affinity group AGₙ has a business or another relationship with the same affinity group AGₙ in addition to potentially receiving offers distributed by the offer exchange system 100. An example of an affinity group AGₙ includes, but is not limited to, an organization, a religious organization, a school, a bank, a team, a company, a special interest group, an online community, an online social network community, an insurance group, or any combination thereof.

At least one of the affinity groups AGₙ has a forum 150 accessible by the affinity group's members M. The forum 150 is established, possibly with the help of or in combination with another party, by the affinity group AGₙ. Types of forums 150 include, but are not limited to, a website, an electronic mail, an online mailing, a physical newsletter, an online newsletter, another type of mailing, or any combination thereof.

FIG. 1 shows an offer exchange system 100 that includes an offer database 110, an offer distributor 120, and a group profiler 130. Sponsors S₁-Sₘ submit offers to the offer exchange system 100 and the offers are stored in the offer database 110. The offer distributor 120 provides a mechanism to distribute the offers to be received by members M of the affinity groups AG₁-AGₙ. For the example shown in FIG. 1, an offer 160 is distributed by the offer exchange system 100 and received by member M* of affinity group AGₙ through the forum 150 established by affinity group AGₙ. The offer 160 is redeemable at a store 170. Upon redemption of the offer 160, redemption data is recorded. Redemption data includes an identification of the store 170 and/or region where the offer 160 was redeemed and the time the offer 160 was redeemed.

Typically, a redemption agent 140 retrieves the redemption data from the store 170 and transmits the redemption data to the offer exchange system 100. The offer exchange system 100 has a mechanism for receiving the redemption data, whereby the group profiler 130 uses the redemption data to profile the affinity group AGₙ . The redemption agent 140 can be an external agent contracted by the offer exchange system 100 or can be a part of the offer exchange system 100. Redemption data can be transmitted through a redemption agent 140, directly to the offer exchange system 100, or through any number of intermediaries.

It is important to note that the offer 160 in FIG. 1 is assigned an identifier 165 by the offer distributor 120 or another component of the offer exchange system 100. The identifier 165 is associated with a product and associated with the affinity group AGₙ of the member M* receiving the offer 160. The association between an affinity group AGₙ and an identifier 165 on an offer 160 allows the group profiler 130 to identify the affinity group AGₙ to be profiled. Optionally, the identifier 165 can be associated with the particular member M* who received the offer 160. The identifier 165 can also be associated with the offer exchange system 100 to enable the redemption data to be transmitted to the offer exchange system 100.

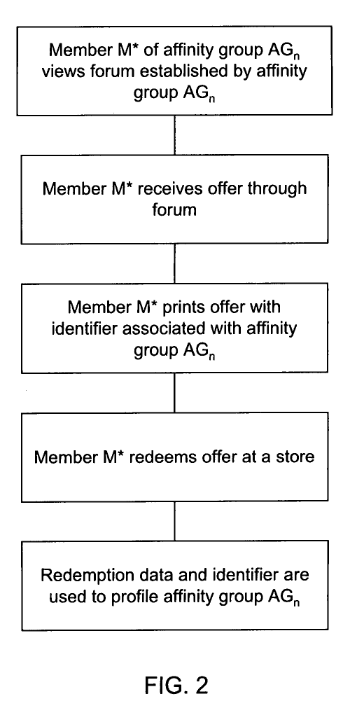

FIG. 2 shows a flow chart that summarizes the steps undertaken by member M* of affinity group AGₙ to receive and redeem an offer from the exemplary offer and reward system in accordance with the present invention. The present invention serves sponsors S₁-Sₘ well by enabling the sponsors S₁-Sₘ to find the reach, relevance, and influence of one or more affinity groups AG₁-AGₙ. At the same time, affinity groups AG₁-AGₙ improve their service to their members M by finding the most valued offers for their group. These goals are not achievable with existing coupon or offer distribution systems.

Without the use of a centralized offer or coupon distribution system, sponsors or commercial enterprises would have difficulties reaching potential customers and must establish their own offer distribution mechanisms. With a separate and distinct distribution mechanism for every sponsor, potential customers must navigate through multiple different forums to receive a variety of coupons or offers. Furthermore, the different forums would naturally have different requirements, such as usemames and passwords. This process of receiving offers from multiple distinct forums can be burdensome and inconvenient for a customer seeking savings.

More centralized offer or coupon distribution systems directed at distributing coupons to individual users exist. Typically, individual users of these systems must find and use a central forum, e.g. a website, established by the coupon distribution system to receive coupons. The received coupons can then be redeemed at a store and the coupon redemption process is managed by a separate coupon redemption service. It is important to note that existing centralized coupon distribution systems provide services for individual users and not groups of users.

Distinct disadvantages exist when coupons or offers are distributed through a centralized distribution system directed at individuals instead of groups. The forum or website is generally not known by many potential customers causing a natural lack of trust to be felt by potential customers pertaining to the validity of the coupons offered. Customers must also be able to easily find the website or extensive advertising is required to reach a large number of potential customers. In addition, if the distributed coupons are used for marketing purposes, the marketing analyses focus on information of individuals. To obtain information of individuals, existing coupon distribution systems typically require individual users to enter personal information. For example, many coupon distribution websites require users to log in with a usemame and password and fill out personal information about the user. Users are often reluctant to enter personal information, especially to an unfamiliar website.

The offer and reward system shown in FIG.1 avoids the above disadvantages by having affinity groups AG₁-AGₙ. Trust issues are mitigated because a member M of an affinity group AGₙ has a pre-existing relationship with the affinity group AGₙ and offers 160 are accessed through a forum 150 established by the trusted affinity group AGₙ. A forum 150 established by an affinity group AGₙ could be easily found and accessed by the members M of the same affinity group AGₙ, thereby eliminating the need for extensive searches or advertisements. Furthermore, members M are not required to enter personal information because profiling is done at the group level and not necessarily at the individual level. In some embodiments, profiles of individuals can also be incorporated. In an embodiment where individual profiling is accomplished, certain affinity groups may already possess information on members of the groups; therefore the members would not need to submit additional member information.

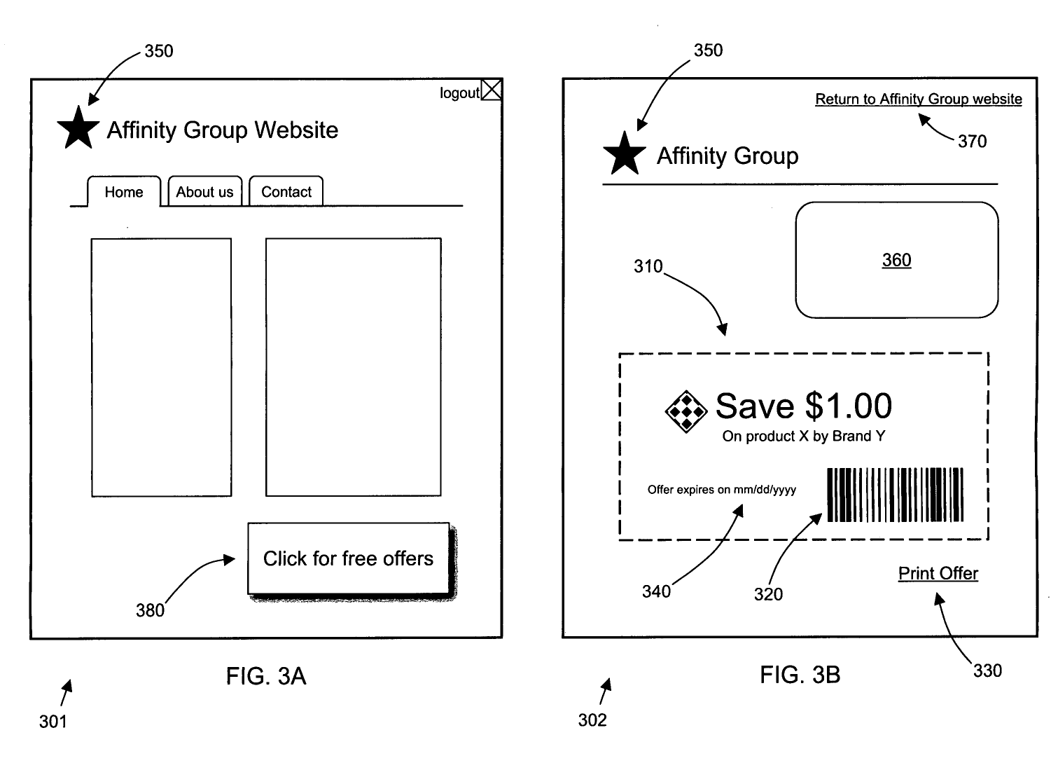

In a preferred embodiment, the forum established by an affinity group is a group website 301. An example of a group website 301 is shown by FIG. 3A. Members of the affinity group may access the group website 301 for any reason, including a reason involving their pre-existing relationship with the affinity group. For example, an affinity group is a bank and bank members access the bank's group website 301 to process financial transactions. Permissions to use the group website 301 are determined by the affinity group establishing the group website 301; members of an affinity group may or may not be required to log in to the group website 301. The group website 301 includes a link 380 to an offer website 302 for distributing offers.

FIG. 3B shows an example of an offer website 302. The offer website 302 preferably does not require a member to log on to receive the offers. The offer website 302 identifies the group website 301 by displaying the name, logo 350, description 360, weblink 370, or another identifying mechanism for a member to identify the group website 301. One or more offers 310 can be displayed on the offer website 302 for distribution to one or more members of the affinity group. Optionally, a member of the affinity group can choose an offer from multiple offers. A distributed offer 310 includes an identifier 320 associated with the affinity group and associated with a product. An expiration date 340 can also be displayed on the offer 310 in human-readable or machine-reachable format. In a preferred embodiment, a hard copy of the offer 310 can be printed 330 and used at a store where the offer 310 is redeemable. The hard copy can also be mailed to a mail-order store or a store that permits mail-in offers. The offer 310 may also include information, such as a code, to be used in the online environment of an online retailer or store. Optionally, members can receive the offer 310 by download, mail, or electronic mail.

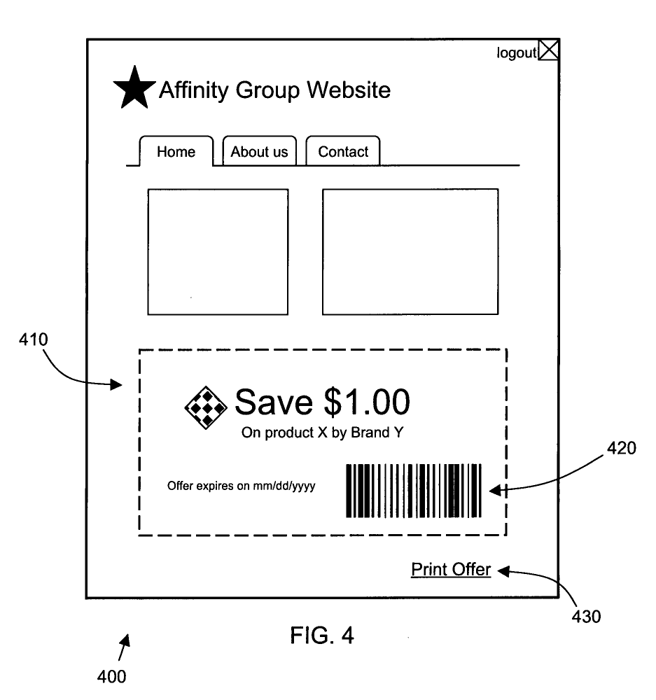

FIG. 4 shows an alternate embodiment for distributing offers that does not require a link from a group website to an offer website. The group website 400 shown in FIG. 4 includes an embedded script, such as a Java script, for retrieving at least an offer 410. The offer 410 can be retrieved from a database storing the offer and includes an identifier 420 associated with the affinity group and associated with a product. The retrieved offer 410 can be printable 430 or otherwise accessible and usable in a similar manner as the offer 310 from the offer website 302 shown in FIG. 3B.

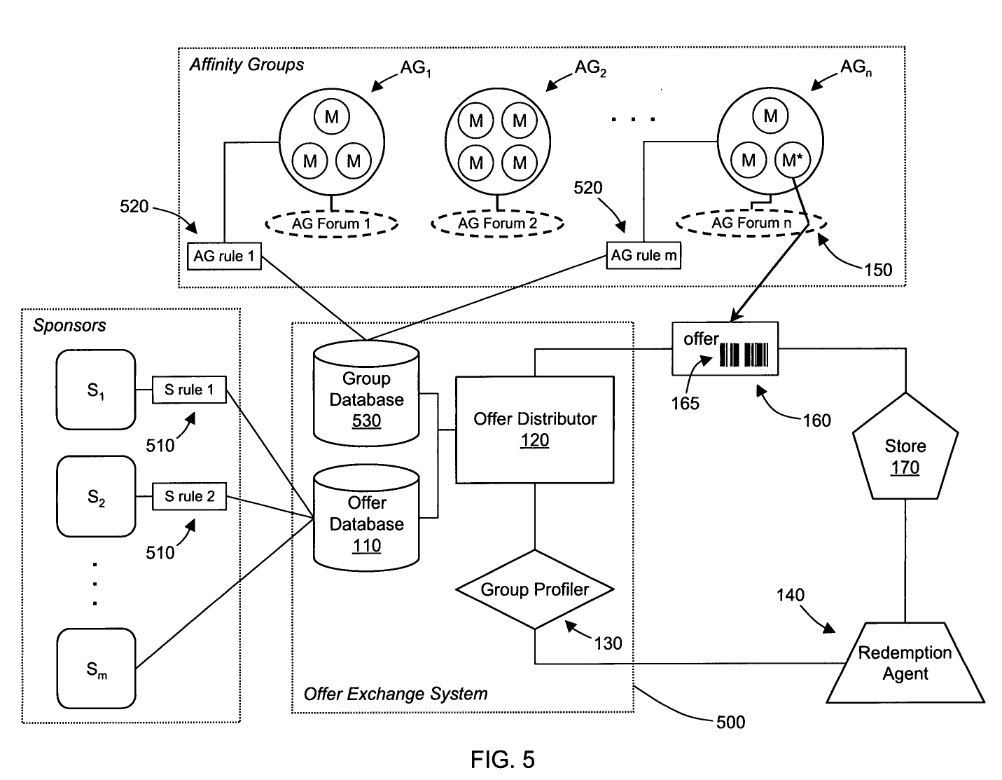

In a preferred embodiment, the identifier 320, 420 of a distributed offer 310, 410 comprises a bar code. The bar code can be in a standard bar code format, a customized bar code format, or any other format as long as it can be associated with an affinity group. The association of the identifier 320, 420 with an affinity group enables the offer to be traced back to the affinity group for profiling purposes. Preferably, a group database 530, shown in FIG. 5, stores group information including information to identify affinity groups based on the bar codes.

A group database 530 may also be used to store one or more group properties of each of the affinity groups AG₁-AGₙ. A group property may include demographic data. The group properties of an affinity group, along with the redemption data, can be used in profiling the affinity group. In particular, profiling can include calculating an effective cost per number of impressions (eCPM) as a function of the group properties and the redemption data for different offers or offer programs. eCPM is typically measured per thousand impressions, though any other number can be used. The group database 530 can also store properties of individual members of the group.

FIG. 5 shows a schematic of an offer and reward system for group profiling similar to the system shown in FIG. 1 with the addition of sponsor rules 510 and affinity group rules 520. A sponsor rule 510 includes one or more restrictions on at least one of the offers. The restrictions can include preventing the distribution of at least one of the offers to particular affinity groups AG₁-AGₙ or particular members M. A sponsor rule 510 can also place various conditions on the amount of savings, expiration date, or another characteristic of an offer. Sponsor rules 510 are determined by the sponsors S₁-Sₘ.

Affinity groups AG₁-AGₙ can determine one or more affinity group rules 520. An affinity group rule 520 includes one or more restrictions on at least one of the offers to be received by the members M of the affinity group determining the rule. The restrictions allow the affinity group to determine which products or sponsors S₁-Sₘ are appropriate for the group. The offer exchange system 500 of FIG. 5 receives sponsor rules 510 and affinity group rules 520. The rules may be stored in the offer database 110 or group database 530. Any number of databases can be used to function as the offer database 110 and the group database 530. By using a matching function for the rules, the offer distributor 120 or any other component of the offer exchange system 500 can determine what products can be distributed to particular affinity groups AG₁-AGₙ and members M.

As one of ordinary skill in the art will appreciate, various changes, substitutions, and alterations could be made or otherwise implemented without departing from the principles of the present invention, e.g. the Internet could be substituted by a local area network and the offers can be for any product or service. Accordingly, the scope of the invention should be determined by the following claims and their legal equivalents.

What is claimed is:

1. A method for group profiling, comprising:
(a) storing a plurality of offers, wherein said plurality of offers are from a plurality of sponsors, wherein said plurality of offers are redeemable at one or more stores;
(b) having a plurality of affinity groups, wherein each of said plurality of affinity groups comprises a plurality of members with a pre-existing relationship with the same of said plurality of affinity groups;
(c) distributing one of said plurality of offers to be received by at least one of said plurality of members of one of said plurality of affinity groups, wherein said distributing is through a forum established by the same of said plurality of affinity groups;
(d) assigning an identifier to said distributed offer, wherein said identifier is associated with a product and is associated with said affinity group of said at least one member receiving said distributed offer; and
(e) receiving redemption data for said distributed offer, wherein said redemption data and said identifier of said distributed offer are for profiling said affinity group associated with said identifier.

2. The method as set forth in claim 1, wherein said forum comprises a group website of the same of said affinity group, wherein said group website comprises a link to an offer website, wherein said distributed offer is distributed at said offer website, wherein said offer website identifies said affinity group establishing said group website.

3. The method as set forth in claim 2, wherein said offer website distributes one of said plurality of offers without requiring logging on to said offer website.

4. The method as set forth in claim 1, wherein said forum comprises a group website, wherein said group website comprises an embedded script, wherein said embedded script retrieves at least said distributed offer from a database storing said distributed offer.

5. The method as set forth in claim 1, wherein said forum comprises a physical newsletter, an online newsletter, a mailing, an online mailing, an electronic mail, a website, or any combination thereof.

6. The method as set forth in claim 1, wherein said identifier of said distributed offer is associated with said at least one member who received said distributed offer.

7. The method as set forth in claim 1, wherein said identifier comprises a bar code, wherein said bar code is associated with said product and is associated with said affinity group of said at least one member receiving said distributed offer.

8. The method as set forth in claim 1, wherein said redemption data of said distributed offer comprises an identification of said store where said distributed offer was redeemed and the time said distributed offer was redeemed.

9. The method as set forth in claim 1, wherein each of said plurality of affinity groups has one or more group properties, wherein said profiling uses said one or more group properties and said redemption data.

10. The method as set forth in claim 9, wherein said profiling comprises calculating an effective cost per number of impressions (eCPM) as a function of said one or more group properties and said redemption data.

11. The method as set forth in claim 1, further comprising enforcing a sponsor rule, wherein said sponsor rule comprises one or more restrictions on at least one of said plurality of offers from one of said plurality of sponsors, wherein said sponsor rule is determined by the same of said plurality of sponsors.

12. The method as set forth in claim 1, further comprising enforcing an affinity group rule, wherein said affinity group rule is determined by one of said plurality of affinity groups, wherein said affinity group rule comprises one or more restrictions on at least one of said plurality of offers distributed to said members of the same of said plurality of affinity groups.

13. The method as set forth in claim 1, wherein one of said affinity groups is an organization, a religious organization, a school, a bank, a team, a company, a special interest group, an online community, an online social network community, an insurance group, or any combination thererof.

14. In an offer and reward system for group profiling, wherein said offer and reward system comprises an offer exchange system, a plurality of sponsors, and a plurality of affinity groups, wherein each of said plurality of affinity groups have multiple members with a pre-existing relationship with the same of said plurality of affinity groups, said offer exchange system comprising:
(a) an offer database for storing said plurality of offers, wherein said plurality of offers are submitted by said plurality of sponsors, wherein said offers are redeemable at one or more stores;
(b) a distribution mechanism for distributing one of said plurality of offers to be received by at least one of said members of one of said plurality of affinity groups, wherein said distributing is through a forum established by the same of said plurality of affinity groups;
(c) an identifier for said distributed offer, wherein said identifier is associated with a product and is associated with said affinity group of said at least one member receiving said distributed offer;
(d) a receive mechanism for receiving redemption data for said distributed offer after said distributed offer is redeemed at said one or more stores; and
(e) a group profiler for profiling said affinity group associated with said identifier of said distributed offer, wherein said profiling is based on said redemption data and said identifier.

15. The offer exchange system as set forth in claim 14, wherein said forum comprises a group website of the same of said affinity group, wherein said group website comprises a link to an offer website, wherein said distributed offer is distributed at said offer website, wherein said offer website identifies said affinity group establishing said group website.

16. The offer exchange system as set forth in claim 15, wherein said offer website distributes one of said plurality of offers without requiring logging on to said offer website.

17. The offer exchange system as set forth in claim 14, wherein said forum comprises a group website, wherein said group website comprises an embedded script, wherein said embedded script retrieves at least said distributed offer from said offer database.

18. The offer exchange system as set forth in claim 14, wherein said forum comprises a physical newsletter, an online newsletter, a mailing, an online mailing, an electronic mail, a website, or any combination thereof.

19. The offer exchange system as set forth in claim 14, wherein said identifier of said distributed offer is associated with said at least one member who received said distributed offer.

20. The offer exchange system as set forth in claim 14, wherein said identifier comprises a bar code, wherein said bar code is associated with said product and is associated with said affinity group of said at least one member receiving said distributed offer.

21. The offer exchange system as set forth in claim 14, wherein said redemption data of said distributed offer comprises an identification of said store where said distributed offer was redeemed and the time said distributed offer was redeemed.

22. The offer exchange system as set forth in claim 14, further comprising a group database for storing one or more group properties for each of said plurality of affinity groups, wherein said one or more group properties and said redemption data are used by said group profiler.

23. The method as set forth in claim 22, wherein said group profiler calculates an effective cost per number of impressions (eCPM) as a function of said redemption data and said one or more group properties of said profiled affinity group.

24. The offer exchange system as set forth in claim 14, further comprising a sponsor rule, wherein said sponsor rule comprises one or more restrictions on at least one of said plurality of offers from one of said plurality of sponsors, wherein said sponsor rule is determined by the same of said plurality of sponsors.

25. The offer exchange system as set forth in claim 14, further comprising an affinity group rule, wherein said affinity group rule is determined by one of said plurality of affinity groups, wherein said affinity group rule comprises one or more restrictions on at least one of said plurality of offers distributed to said members of the same of said plurality of affinity groups.

26. The offer exchange system as set forth in claim 14, wherein one of said affinity groups is an organization, a religious organization, a school, a bank, a team, a company, a special interest group, an online community, an online social network community, an insurance group, or any combination thererof.
